(19) United States
(12) Patent Application Publication
(10) Pub. No.: US 2015/0371175 A1
(43) Pub. Date: Dec. 24, 2015

(54) ENTERPRISE MOBILE APPLICATION FOR MONITORING PROCESS INTEGRATION SERVERS

(71) Applicant: SANDEEP VOONA, Bangalore (IN)

(72) Inventor: SANDEEP VOONA, Bangalore (IN)

(21) Appl. No.: 14/307,490

(22) Filed: Jun. 18, 2014

(51) Int. Cl. G06Q 10/06; H04L 29/08; H04L 12/26; H04L 12/24

(52) U.S. Cl. CPC G06Q 10/063114; H04L 41/22; H04L 67/025; H04L 43/10

(57) ABSTRACT

Methods and system are disclosed that assist in monitoring process integration servers by an app on a mobile device. In one aspect, a user interface is provided via the app on the mobile device. The user interface renders information related to process integration servers monitored by a central monitoring framework. Upon selecting a process integration server, adapter engines and an associated monitoring types are determined. The determined adapter engines and associated monitoring types are rendered on a user interface of the app and an adapter engine and associated monitoring type is selected. Upon such a selection, the app on the mobile device retrieves monitoring attributes indicating status information corresponding to the selected monitoring type. The monitoring attributes are displayed on a user interface of the app on the mobile device. The monitoring activities of the process integration servers may be executed via the app on the mobile device.

### BACKGROUND

Monitoring applications and processes plays a significant role in an enterprise. Such monitoring activities may be accomplished using monitoring systems that may be deployed on-premise in the enterprise. System administrators may login into such on-premise monitoring systems to monitor the status of applications and processes. However, executing such monitoring activities by the system administrators outside the regular business hours or while the systems administrators are outside the office may be challenging.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating a mobile device including an app, according to an embodiment.

FIG. 2 is a flow diagram illustrating a process for managing sales activities by an app on a mobile device, according to an embodiment.

FIG. 3 is a block diagram illustrating a screen of a mobile device showing a user interface provided by an app, according to an embodiment.

FIG. 4 is a block diagram illustrating a screen of a mobile device showing a user interface provided by an app, according to an embodiment.

FIG. 5 is a block diagram illustrating a screen of a mobile device showing a user interface provided by an app, according to an embodiment.

FIG. 6 is a block diagram illustrating a screen of a mobile device showing a user interface provided by an app, according to an embodiment.

FIG. 7 is a block diagram illustrating a screen of a mobile device showing a user interface provided by an app, according to an embodiment.

FIG. 8 is a block diagram illustrating a screen of a mobile device showing a user interface provided by an app, according to an embodiment.

FIG. 9 is a block diagram illustrating a screen of a mobile device showing a user interface provided by an app, according to an embodiment.

FIG. 10 is a block diagram of a computer system, according to an embodiment.

### DETAILED DESCRIPTION

Embodiments of techniques related to an enterprise mobile application for monitoring process integration servers are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

Enterprises and other organizations are becoming increasingly dependent on integrated applications, and the need for such integrated applications is growing. Integrated applications may include integration of enabling technologies, such as, web technologies, enterprise software applications and systems, data sources, etc. The integration of applications may also be referred to as Enterprise Application Integration (EAI) may provide unrestricted and seamless sharing of data, information, business processes, etc., in the enterprises.

EAI software applications (e.g., SAP NetWeaver® Process Integration, a product of SAP AG Company) may integrate and facilitate exchange of information including business data between applications, systems, business processes, etc., in an enterprise. Such information may be exchanged among the enterprise's internal applications or systems (e.g., applications or system of different departments or business units), or with applications or systems of external or third-party enterprises. A process model (e.g., an integration scenario) may be used for modeling such applications, systems, business processes, etc. into application components. For example, when a utility of an application spans over different departments in the enterprise, an application component may represent one part of the process that is performed in one department. Application components may be executed on different systems and may have a business relationship with each other. Such business relationships may facilitate communication or exchanging data, thereby maintaining a value chain of the business processes, etc., in the enterprise.

The application components may communicate with each other using remote function calls that may be referred to as “point-to-point” or “direct communication.” The number of application components may increase with the number of applications, thereby increasing the complexity of the business relationships. In such a scenario, a central instance, also referred to as “middleware” may “mediate communication” between the application components. Mediation of communication may be carried out by exchanging messages (e,g., Xtensible Markup Language (XML) messages) that may contain business data exchanged between the systems involved in a cross-component business process.

Mediated communication may occur via communication channels between the application components or cross-component business processes. The activities and functions of the application components, the messages between the application components and the communication channel may need to be monitored to ensure efficient execution of the business processes. Such monitoring may be accomplished using various monitoring tools (e.g., Network Analyzer, Runtime workbench, integration engine monitoring, etc.). A centralized monitoring framework may provide a common interface and be built for monitoring the application components, the messages, the communication channels, etc. Further, a mobile application may communicate with the centralized framework for providing monitoring activities.

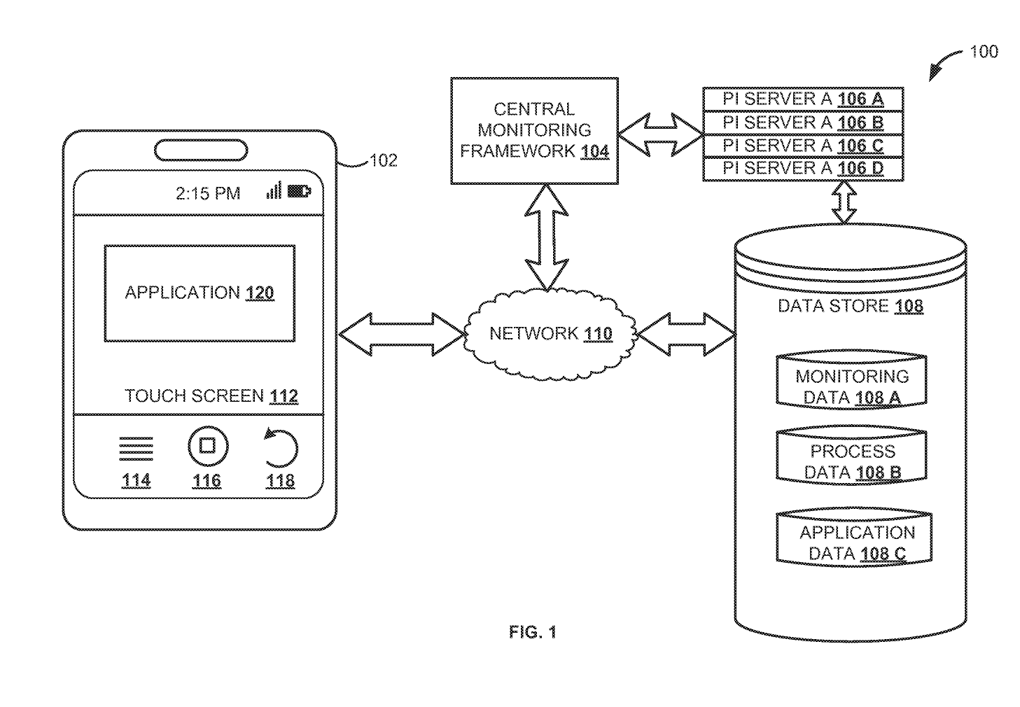

FIG. 1 is a block diagram illustrating a mobile device 100 including an app, according to an embodiment. In an embodiment, block diagram illustrates mobile device 102 in communication with central monitoring framework 104, multiple process integration (PI) servers 106 A-106 D, and data store 108 aver network 110. In an embodiment, central monitoring framework 104 may include protocols configured to route data between mobile device 102 and central monitoring framework 104; collate monitoring data from PI servers 106 A, 106 8, 106 C, and 106 D for consumption by end user using mobile device 102; filter and collate data from the data store 108, etc. Data collation may refer to assimilating or gathering data from different data stores into PI servers, assimilating data from PI servers into the central monitoring framework, etc.

In an embodiment, data store 108 stores business data including monitoring data 108 A, process data 108 B (e.g., data related to business processes), application data 108 C, etc., associated with an enterprise. Data store 108 may represent a database, an in-memory database, an operational data store, a web based data service, a database deployed in a cloud computing environment, etc., containing structured and unstructured data. The business data may be stored in multiple data structures, for example, tables, tree structures or graphs in the data store.

In an embodiment, mobile device 102 includes touch screen interface 112 to display and enable user interaction. The mobile device 102 includes buttons, such as, menu button 114, home button 116, back button 118, etc. and application 120 for monitoring PI servers 106 A, 106 B, 106 C, and 106 D. The application 120 may include multiple user interfaces (not shown, e.g., first user interface, second user interface, third user interface, a fourth user interface, etc.) to support execution of operations, such as, establishing a connection with central monitoring framework 104, accessing and retrieving business data onto mobile device 102, providing user interfaces for selecting adapter engines and associated monitoring types, providing user interfaces for displaying status of PI servers, adding a new PI server to the central monitoring framework 104, etc.

In an embodiment, application 120 may include a user interface to receive input parameters from a user and establish a connection with central monitoring framework 104. Upon establishing the connection, application 120 may access and retrieve business data (e.g., monitoring data) collated at central monitoring framework 104 onto mobile device 102. The monitoring data may include information related to PI servers 106 A-106 D monitored by central monitoring framework 104. Such information may be rendered on a user interface of application 120 on mobile device 102.

In an embodiment, from the UI, a PI server may be selected. Upon receiving a selection of the PI server, application 120 on mobile device 102 may execute business logic to determine adapter engines and monitoring types associated with the selected PI server. The associated adapter engines and the monitoring types are retrieved and displayed on a user interface associated with application 120. Upon selecting an adapter engine and associated monitoring type, the UI associated with application 120 on the mobile device displays monitoring attributes associated with the selected monitoring type. The monitoring attributes associated with the selected monitoring type indicate status information of the selected PI server.

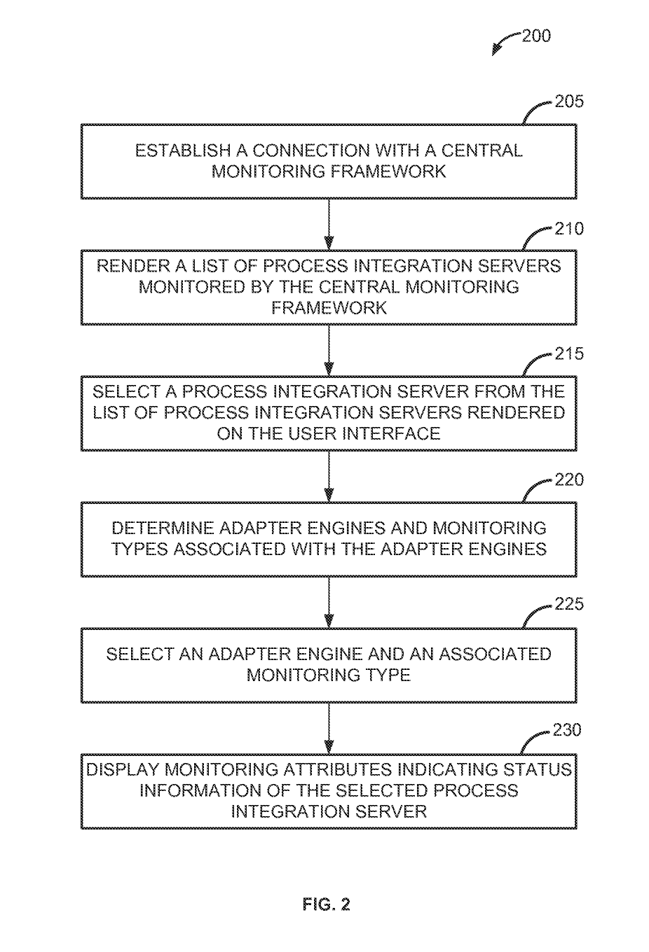

FIG. 2 is a flow diagram illustrating process 200 for monitoring process integration servers by an application on a mobile device, according to an embodiment. Process 200, upon execution, provides a mechanism to monitor process integration servers via an application on a mobile device. The application on the mobile device, herein referred to as “mobile application” or “mobile app” or “app”, may be configured to establish a connection with a central monitoring framework that monitors multiple process integration (PI) servers. The PI servers may be in communication with remotely located data stores that store structured and unstructured business data including information related to monitoring of processes and application components. The PI servers may be configured to filter and access business data related to monitoring of process and application components.

In an embodiment, the central monitoring framework may include an integration of multiple tools and applications that may facilitate monitoring of business processes and application components. The central monitoring framework may also include multiple protocols for structuring business data collated by the PI servers from the data stores, filtering and accessing monitoring data from PI servers, facilitate communication between the central monitoring framework and the app on the mobile device, etc. By way of example, standard structuring and communication protocols, such as, JavaScript Objection Notion (JSON) and Representational State transfer (REST) may be used for transmission of data between the central monitoring framework and the mobile device. The central monitoring framework may access monitoring data of business processes and application components from the PI servers in real time and provide an update on the status of application components and business processes.

In an embodiment, data stores may include structured and unstructured business data including information related to business processes, applications and systems of an enterprise. A process model may be used for modelling such business processes, applications and systems into application components that may exchange data with each other using messages, such as, XML messages. By way of example, consider “John Smith,” an employee working with information technology (IT) department of an organization “XYZ Inc.” “John Smith” administers or monitors application components and the communication between the application components in the organization. “John Smith” may need to execute monitoring activities beyond regular business hours or when he is travelling.

In an embodiment, Table 1 exemplarily illustrates PI servers monitored via the central monitoring framework by “John Smith.”

TABLE 1

| PROCESS | | |
|---|---|---|
| INTEGRATION (PI) | ADAPTER | |
| SERVER NAME | ENGINES | MONITORING TYPES |
| A | AE1 | Component Monitoring, |
| | | Communication Channel |
| | | Monitoring, Alert Monitoring |
| | AE2 | Message Monitoring, Alert |
| | | Monitoring, Communication |
| | | Channel Monitoring |
| | AE3 | Message Monitoring, |
| | | Communication Channel |
| | | Monitoring |
| B | AE6 | Component Monitoring, |
| | | Communication Channel |
| | | Monitoring, Message |
| | | Monitoring, Alert Monitoring |
| | AE7 | Component Monitoring, |
| | | Communication Channel |
| | | Monitoring |
| | AE8 | Message Monitoring, Alert |
| | | Monitoring, Communication |
| | | Channel Monitoring |
| C | AE10 | Alert Monitoring |
| | AE 11 | Component Monitoring, |
| | | Communication Channel |
| | | Monitoring, Message |
| | | Monitoring, Alert Monitoring |
| D | AE3 | Message Monitoring, Alert |
| | | Monitoring, Communication |
| | | Channel Monitoring |
| | AE4 | Component Monitoring, |
| | | Communication Channel |
| | | Monitoring |
| E | AE5 | Component Monitoring, |
| | | Communication Channel |
| | | Monitoring, Message |
| | | Monitoring, Alert Monitoring |

The columns of Table 1 correspond to parameters ‘PI Server Name’, ‘Adapter Engines’ and ‘Monitoring Types.’ The rows of Table 1 correspond to parameter values. For instance, parameter values corresponding to first row includes ‘A’ as the ‘PI Server Name’; ‘AE1’, ‘AE2’ and ‘AE3’ as the ‘Adapter Engines’ associated with PI server ‘A’; and ‘Component Monitoring’, ‘Communication Channel Monitoring’, ‘Alert Monitoring’ as the types of monitoring associated with ‘AE1,’ and so on.

In an embodiment, the monitoring type ‘Component Monitoring’ may indicate: status of application components, configuration data of application components; test messages associated with runtime status of application components, test messages associated with cache connectivity, security settings, communication channels; data associated with the adapter engine, etc. The above indications may be represented by monitoring values corresponding to attributes associated with ‘Component Monitoring’ and may be used to indicate status information of the application components.

In an embodiment, the monitoring type ‘Message Monitoring’ may indicate: status of messages, errors and causes for such errors, etc. ‘Message monitoring’ enables displaying and managing messages, displaying message overview, searching for messages using an index, filtering messages based on specific criteria, configuring the message display, edit messages, etc. The above indications and functions may be represented by monitoring attributes associated with ‘Message Monitoring’ and may be used to indicate status information of the messages between the application components.

In an embodiment, the monitoring type ‘Communication Channel Monitoring’ may indicate information related to communication channels that are set up for the selected adapter engine. The monitoring attributes associated with the ‘Communication Channel Monitoring’ may include a name of communication channel; status of communication channel indicated by a color, for example, green color may indicated that the communication channel has started and functioning without errors, red color may indicate the communication channel has started but may have errors, yellow color may indicate that the communication channel has started but is inactive, grey color may indicate the communication channel has stopped, etc.

The monitoring attributes associated with the ‘Communication Channel Monitoring’ may also include a short log, describing the status of the communication channel, and in event of an error, describing the type of error; control information indicating how the communication channel is controlled (for e.g. Manual, Automatic, Web-based, External, etc.); adapter engine type; direction of communication (e.g., sender or receiver channel, etc.); number of nodes indicating the number of nodes when the communication channel consists of multiple instances on different nodes of a server cluster, etc. The above monitoring attributes associated with the ‘Communication Channel’ may be used to indicate the status information of the communication channel between the application components.

In an embodiment, the monitoring type ‘Alert Monitoring’ may be used to configure alert notifications in an event of error in application components. For example, alert categories including alert rules may be created using the ‘Alert Monitoring’ monitoring type to track errors. The monitoring attributes associated with ‘Alert Monitoring’ may be used for controlling the connection of alerts from the adapter engine to the central monitoring framework and indicate a status information of the application components.

In an embodiment, “John Smith” may execute such monitoring activities using an app on his mobile device. “John Smith” may activate the app on his mobile device by actions, such as a tap, a slide, or a swipe. At a first instance of activation, the app may provide a user interface (UI) to receive input parameters for user authentication, establishing a connection with a central monitoring framework, etc. By way of example, the input parameters corresponding to user authentication may include a user name, a password, etc. The input parameters for establishing the connection with the central framework may include a host number, a port number, etc., associated with the central monitoring framework.

Upon receiving the input parameters and authenticating the user, the app on the mobile device establishes a connection with the central monitoring framework, at 205. Upon establishing the connection, the app on the mobile device retrieves information from the central monitoring framework. This information includes data related to the PI servers that are monitored by the central monitoring framework. At 210, a UI associated with the app renders data related to the PI servers (for e.g. a list of PI servers) that are monitored by the central monitoring framework. The central monitoring framework may associate the PI servers with identifiers. From the list of PI servers rendered on the UI, “John Smith” may select a PI server for monitoring, at 215. By way of example, “John Smith” selects PI server ‘B’ for monitoring.

Upon selecting PI server ‘B’, a business logic associated with the app may be triggered. The associated business logic determines adapter engines and monitoring types associated with the adapter engines, at 220. By way of example, considering Table 1, upon selecting PI server ‘B’, the business logic associated with the app determines ‘AE6’, ‘AE7’ and AE8’ as the associated adapter engines and their respective ‘Monitoring Types’ as ‘Component Monitoring’, ‘Communication Channel Monitoring’, ‘Message Monitoring’, ‘Alert Monitoring’; ‘Component Monitoring’, ‘Communication Channel Monitoring’; and ‘Message Monitoring’, ‘Alert Monitoring’, ‘Communication Channel Monitoring.’ At 225, “John Smith” may select an adapter engine, for example, ‘AE8’ and an associated monitoring type, for example, ‘Communication Channel Monitoring’. Upon selecting the adapter engine and the monitoring type, the app on the mobile device communicates with the central monitoring framework and retrieves monitoring data corresponding to the selected PI server, adapter engine and monitoring type. Upon retrieving such monitoring data, a UI associated with the app displays monitoring attributes, at 230, thereby indicating the status information of the selected PI server.

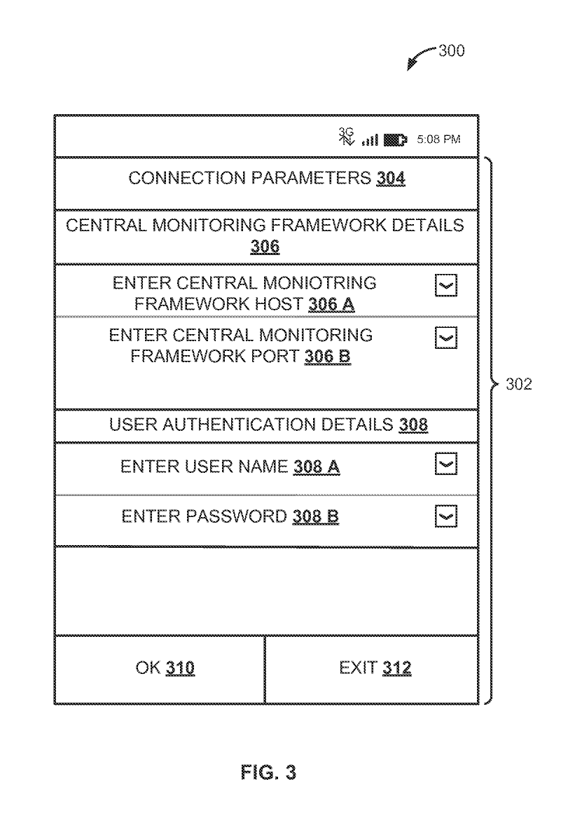

FIG. 3 is a block diagram illustrating screen 300 of a mobile device showing user interface provided by an app, according to an embodiment. For example, FIG. 3 may show user interface 302 of the app 120 on mobile device 102 that establishes a connection with a central monitoring framework 104 (see FIG. 1). In an embodiment, user interface 302 is configured to receive connection parameters 304 for establishing the connection with central monitoring framework (e.eg., 104). The connection parameters 304 include central monitoring framework details 306, user authentication details 308, etc. The parameters corresponding to central monitoring framework details 306 include central monitoring framework host 306 A, central monitoring framework port 306 B, etc. The parameters corresponding to user authentication details 308 include user name 308 A, password 308 B, etc. of the end user. Upon entering the corresponding parameters in their respective fields, and selecting OK 310, the app (e.g., 120) establishes the connection with the central monitoring framework (e.g., 104) and retrieves business data including information related to PI servers monitored by the central monitoring framework. The user may exit the application, e.g., by selecting EXIT 312.

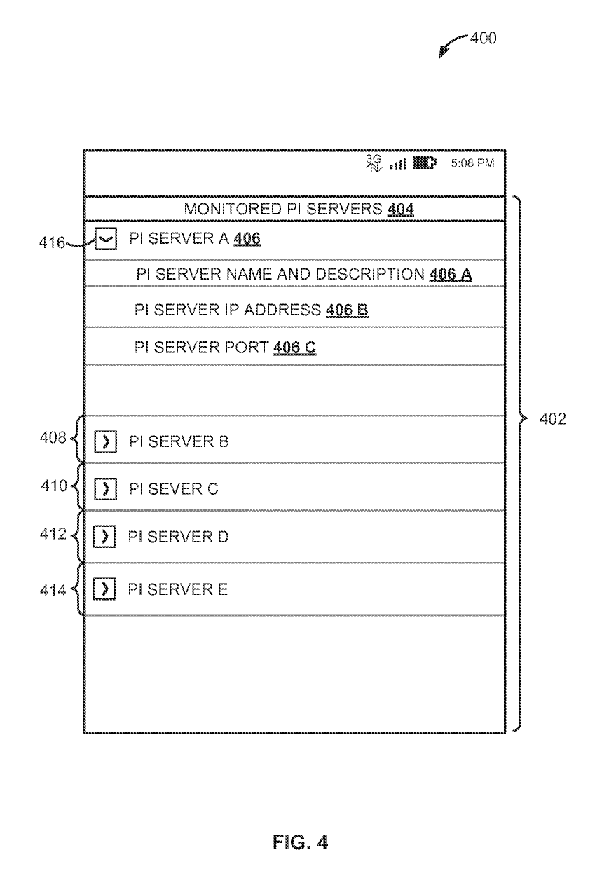

FIG. 4 is a block diagram illustrating screen 400 of a mobile device showing user interface 402 provided by an app, according to an embodiment. In an embodiment, upon establishing the connection with central monitoring framework, the app retrieves business data collated at central monitoring framework onto the mobile device (e.g., mobile device 102 of FIG. 1). User interface 402 associated with app renders information related to PI servers monitored (e.g., monitored PI servers 404) by the central monitoring framework. In an embodiment, the details associated with a PI server may be accessed by selecting dropdown control 416. By way of example, upon clicking on 416, the details associated with the PI servers, for example, PI server A 406 including PI Server name and description 406 A, an internet protocol (IP) address of the PI server 406 B, a PI server port 406 C, etc., are displayed on user interface 402. The user interface 402 shows information related to PI servers monitored by the central monitoring framework (e.g., 104 in FIG. 1), PI server B 408, PI server C 410, PI server D 412, and PI server E 414.

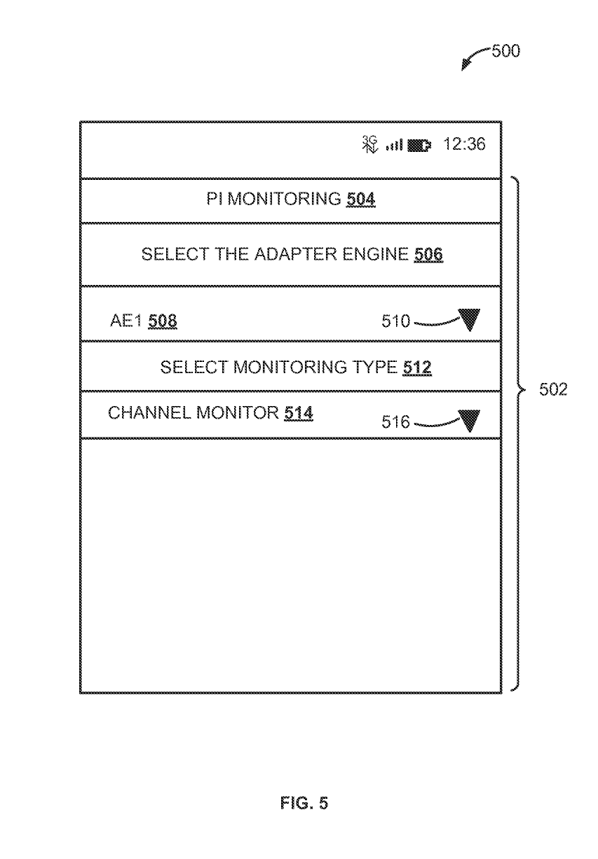

FIG. 5 is a block diagram illustrating screen 500 of a mobile device showing user interface 502 provided by an app, according to an embodiment. User interface 502 renders information related to monitoring the PI servers 504. In an embodiment, upon selecting the PI server, the adapter engines and monitoring types associated with the selected PI server are determined and retrieved from the central monitoring framework. The adapter engines and monitoring types associated with the PI server are rendered on user interface provided by the app (e.g., 120 of FIG. 1) on the mobile device. FIG. 5 shows user interface 502 rendering an option to select the adapter engine 506 and the associated monitoring type 512 with the selected adapter engine. User interface 502 renders AE1 508 as the adapter engine and channel monitor 514 as the associated monitoring type 512. Other adapter engines may be selected by clicking on 510 and the associated monitoring types may be selected by clicking on 516 on the user interface 502.

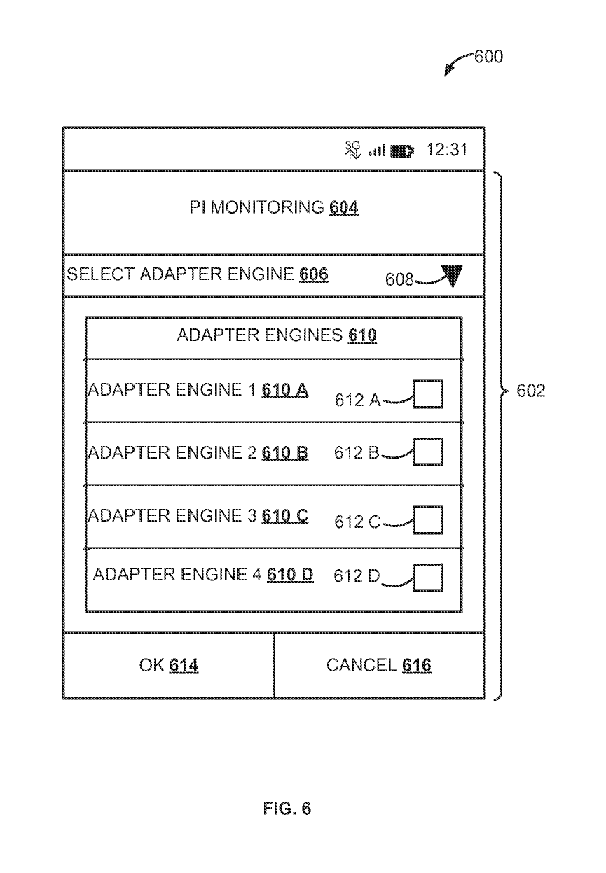

FIG. 6 is a block diagram illustrating screen 600 of a mobile device showing user interface 602 provided by an app, according to an embodiment. In an embodiment, upon selecting (e.g. via a gesture, like, a tap, a slide, etc.) on graphical element associated with adapter engines, the associated drop down Menu on the user interface is instantiated. The drop down menu renders information related to the adapter engines associated with the selected PI server. FIG. 6 shows a user interface 602 rendering information related to monitoring PI servers 604, An adapter engine is selected 606 by selecting dropdown control 608. Upon clicking on 608, the adapter engines 610 are rendered on the user interface 602. The user interface 602 renders adapters engines 610 A, 610 B, 610 C and 610 D, where a user may select one or more adapter engines by clicking on their respective check boxes 612 A, 612 B, 612 C and 612 D. Upon selecting the adapter engines, the user may select OK 614 or may select CANCEL 616 to cancel selecting the adapter engines.

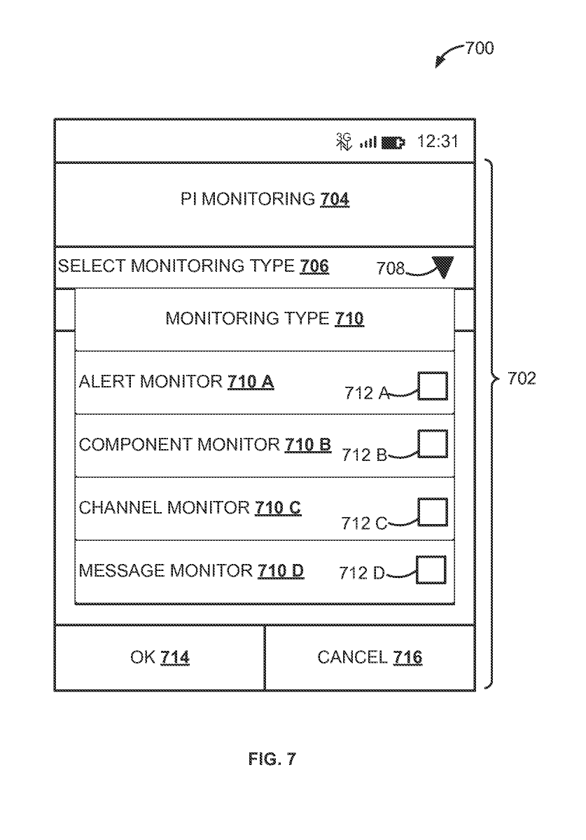

FIG. 7 is a block diagram illustrating screen 700 of a mobile device showing user interface 702 provided via by an app, according to an embodiment. In an embodiment, upon receiving a selection (e.g. via a gesture, like, a tap, a slide, etc.) on graphical element associated with monitoring types, the associated drop down menu on the user interface is instantiated. The drop down menu renders information related to the monitoring types associated with the selected adapter engine and PI Server. FIG. 7 shows a user interface 702 rendering information related to monitoring PI servers 704. A monitoring type is selected 706 by clicking on 708. Upon clicking on 708, the monitoring type 710 is rendered on the user interface 702. The user interface 602 renders monitoring types namely ‘Alert Monitor’ 710 A, ‘Component Monitor’ 710 B, ‘Channel Monitor’ 710 C and ‘Message Monitor’ 710 D, where a user may select one or more monitoring types by clicking on their respective check boxes 712 A, 712 B, 712 C and 712 D. Upon selecting the monitoring type, the user may select OK 714 to proceed with fetching the monitoring attributes corresponding to the selected monitoring types or may select CANCEL 716 for canceling the operation of selecting the monitoring type.

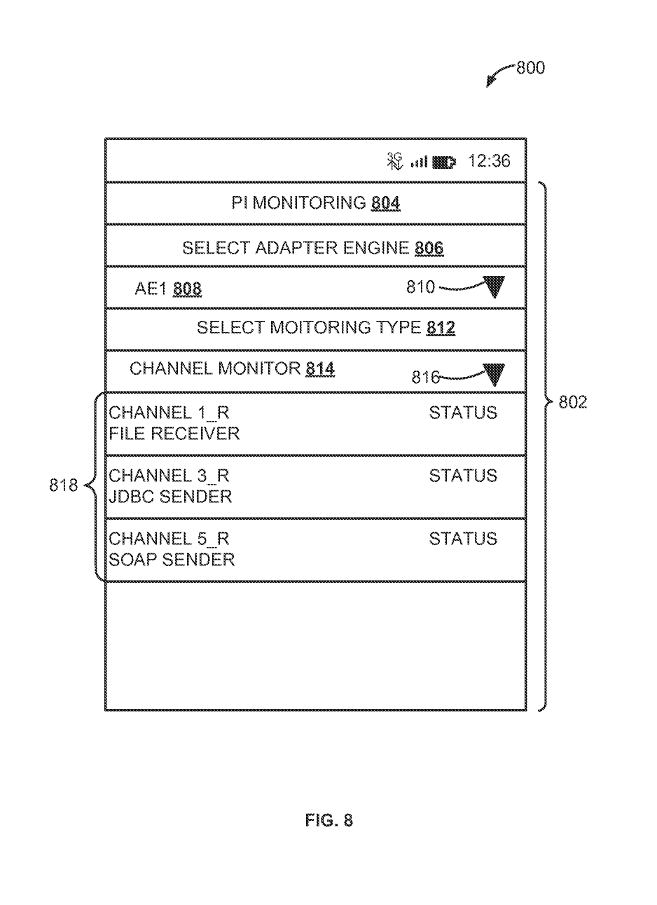

FIG. 8 is a block diagram illustrating screen 800 of a mobile device showing user interface 802 provided by an app, according to an embodiment. User interface 802 renders information related to monitoring the PI servers 804. In an embodiment, upon selecting the PI server, the adapter engines and monitoring types associated with the selected PI server are determined and retrieved from the central monitoring framework (e.g. 104 in FIG. 1). The adapter engines and monitoring types associated with the PI server are rendered on user interface of provided by the app on the mobile device. FIG. 8 shows user interface 802 rendering an option to select the adapter engine 806 and the associated monitoring type 812 with the selected adapter engine. User interface 802 renders AE1 808 as the adapter engine and channel monitor 814 as the associated monitoring type 812. Other adapter engines may be selected by clicking on 810 and the associated monitoring types may be selected by clicking on 816 on the user interface 802. As shown in FIG. 8, user interface 802 renders monitoring attributes 818 corresponding to channel monitor 814.

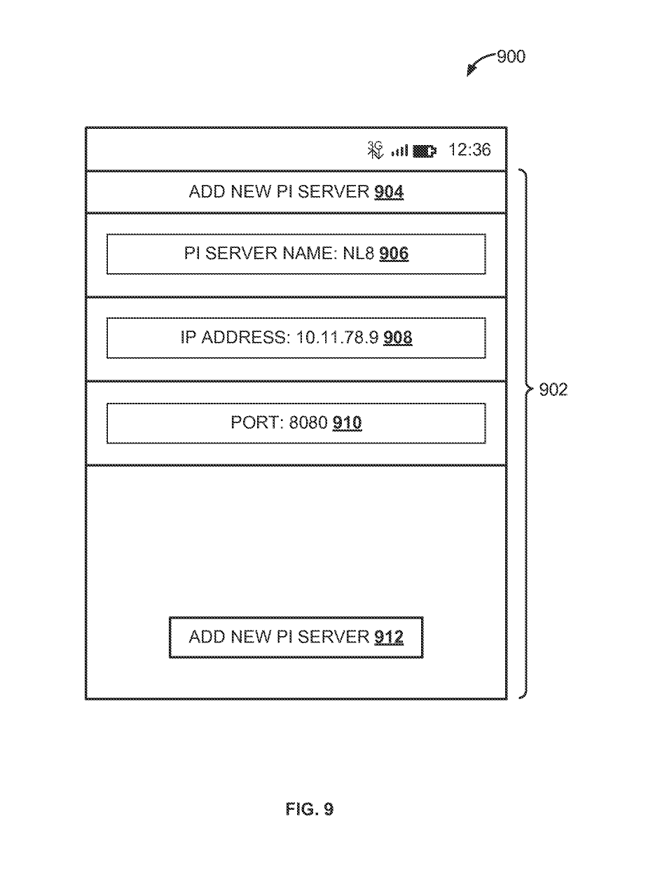

FIG. 9 is a block diagram illustrating screen 900 of a mobile device showing user interface 902 provided by an app, according to an embodiment. In an embodiment, a new PI server to be monitored may be added via the app (e.g. 120 in FIG. 1) on the mobile device (e.g. 102). FIG. 9 shows a user interface 902 for adding a new PI server 904. The user interface 902 includes data fields such as ‘PI Sever Name’ 906, ‘IP Address’ 908 of the PI Server, ‘Port Number’ 910 of the PI server, etc. Upon entering values in the respective data fields 906, 908 and 910 and clicking on button ‘Add New PI Server’ 912, the central monitoring framework adds the new PI server for monitoring.

In an embodiment, the central monitoring framework may be integrated with a PI system. The PI system may facilitate administering and monitoring activities. The monitoring activities may be executed via an app on the mobile device. As discussed previously, the app may be configured to connect to the central monitoring framework to execute monitoring activities. In another embodiment, the central monitoring framework may be configured as a stand-alone application that may be installed on a server. The PI servers to be monitored may be communicatively coupled with the server on which the stand-alone application corresponding to the central monitoring framework is installed. As explained previously, the PI servers may be monitored via the app on the mobile device.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a tangible computer readable storage medium. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

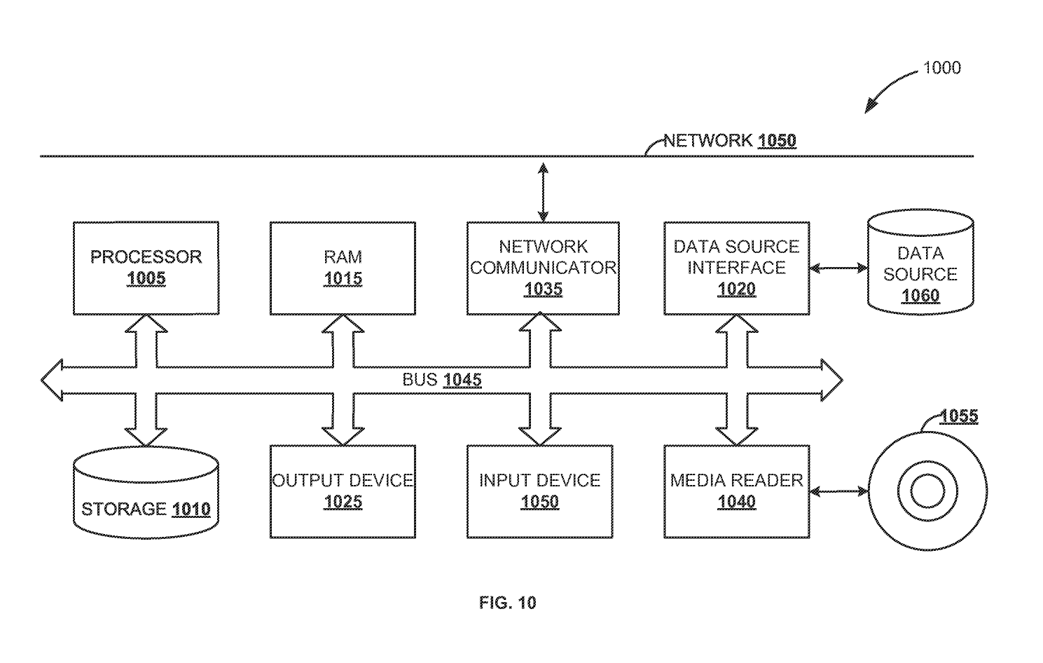

FIG. 10 is a block diagram of an exemplary computer system 1000, according to an embodiment. Computer system 1000 includes processor 1005 that executes software instructions or code stored on computer readable storage medium 1055 to perform the above-illustrated methods. Processor 1005 can include a plurality of cores. Computer system 1000 includes media reader 1040 to read the instructions from computer readable storage medium 1055 and store the instructions in storage 1010 or in random access memory (RAM) 1015. Storage 1010 provides a large space for keeping static data where at least some instructions could be stored for later execution. According to some embodiments, such as sonic in-memory computing system embodiments, RAM 1015 can have sufficient storage capacity to store much of the data required for processing in RAM 1015 instead of in storage 1010. In some embodiments, all of the data required for processing may be stored in RAM 1015. The stored instructions may be further compiled to generate other representations of the instructions and dynamically stored in RAM 1015. Processor 1005 reads instructions from RAM 1015 and performs actions as instructed. According to one embodiment, computer system 1000 further includes output device 1025 (e.g., a display) to provide at least some of the results of the execution as output including, but not limited to, visual information to users and input device 1030 to provide a user or another device with means for entering data and/or otherwise interact with computer system 1000. Each of these output devices 1025 and input devices 1030 could be joined by one or more additional peripherals to further expand the capabilities of computer system 1000. Network communicator 1035 may be provided to connect computer system 1000 to network 1050 and in turn to other devices connected to network 1050 including other clients, servers, data stores, and interfaces, for instance. The modules of computer system 1000 are interconnected via bus 1045. Computer system 1000 includes a data source interface 1020 to access data source 1060. Data source 1060 can be accessed via one or more abstraction layers implemented in hardware or software. For example, data source 1060 may be accessed by network 1050. In some embodiments data source 1060 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Data Base Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope, as those skilled in the relevant art will recognize. These modifications can be made in light of the above detailed description. Rather, the scope is to be determined by the following claims, which are to be interpreted in accordance with established doctrines of claim construction.

What is claimed is:

1. A computer implemented method to monitor a status of a process integrated server, comprising:
upon establishing a connection with a central monitoring framework, a first user interface associated with an application on a mobile device rendering a list of a plurality of process integration servers monitored by the central monitoring framework;
on the rendered list of plurality of process integration servers, receiving a selection of a process integration server;
for the selected process integration server, a processor of the mobile device determining one or more adapter engines and one or more monitoring types associated with the one or more adapter engines; and
upon receiving a selection of at least one adapter engine and at least one corresponding monitoring type, displaying a second user interface associated with the application on the mobile device, wherein the second user interface includes one or more monitoring attributes indicating status information related to the selected process integration server.

2. The computer implemented method of claim 1, wherein the central monitoring framework includes a plurality of protocols for structuring data collated from the plurality of process integration servers.

3. The computer implemented method of claim 1, wherein the plurality of monitoring types are selected from a group consisting of a component monitoring, a channel monitoring, a message monitoring and an alert monitoring.

4. The computer implemented method of claim 1, further comprising: configuring the central monitoring framework to determine the plurality of process integration servers based on one or more identifiers associated with the plurality of process integration servers.

5. The computer implemented method of claim 1, wherein the central monitoring framework includes one or more integrated monitoring tools for monitoring the plurality of process integration servers.

6. The computer implemented method of claim 1, wherein the plurality of process integration servers is configured to collate business data from a plurality of data stores located remotely.

7. A computer system to manage sales activities, comprising:
a processor; and
one or more memory devices communicatively coupled with the processor and one or more memory devices storing instructions to:
render a list of a plurality of process integration servers monitored by a central monitoring framework on a first user interface associated with an application on a mobile device based on a connection established with the central monitoring framework;
on the rendered list of plurality of process integration servers, receive a selection of a process integration server;
for the selected process integration server, determine one or more adapter engines and one or more monitoring types associated with the one or more adapter engines; and
upon receiving a selection of at least one adapter engine and at least one corresponding monitoring type, display one or more monitoring attributes indicating status information related to the selected process integration server on a second user interface associated with the application on the mobile device.

8. The computer system of claim 7, wherein the central monitoring framework includes a plurality of protocols for structuring data collated from the plurality of process integration servers.

9. The computer system of claim 7, wherein the plurality of monitoring types are selected from a group consisting of a component monitoring, a channel monitoring, a message monitoring and an alert monitoring.

10. The computer system of claim 7, further comprising: configure the central monitoring framework to determine the plurality of process integration servers based on one or more identifiers associated with the plurality of process integration servers.

11. The computer system of claim 7, wherein the central monitoring framework includes one or more integrated monitoring tools for monitoring the plurality of process integration servers.

12. The computer system of claim 7, wherein the plurality of process integration servers is configured to collate business data from a plurality of data stores located remotely.

13. A non-transitory computer readable storage medium tangibly storing instructions, which when executed by a computer, cause the computer to execute operations comprising:
render a list of a plurality of process integration servers monitored by a central monitoring framework on a first user interface associated with an application on a mobile device based on a connection established with the central monitoring framework;
on the rendered list of plurality of process integration servers, receive a selection of a process integration server;
for the selected process integration server, determine one or more adapter engines and one or more monitoring types associated with the one or more adapter engines; and
upon receiving a selection of at least one adapter engine and at least one corresponding monitoring type, display one or more monitoring attributes indicating status information related to the selected process integration server on a second user interface associated with the application on the mobile device.

14. The non-transitory computer readable storage medium of claim 13, wherein the central monitoring framework includes a plurality of protocols for structuring data collated from the plurality of process integration servers.

15. The non-transitory computer readable storage medium of claim 13, wherein the plurality of monitoring types are selected from a group consisting of a component monitoring, a channel monitoring, a message monitoring and an alert monitoring.

16. The non-transitory computer readable storage medium of claim 15, wherein one or more monitoring attributes associated with the component monitoring includes status of application components, configuration data of application components and data associated with one or more adapter engines.

17. The non-transitory computer readable storage medium of claim 15, wherein one or more monitoring attributes associated with the communication channel includes status of communication channel, type of error and controlling information associated with the communication channel.

18. The non-transitory computer readable storage medium of claim 13, further comprising instructions, which when executed by the computer, cause the computer to execute operations comprising: configure the central monitoring framework to determine the plurality of process integration servers based on one or more identifiers associated with the plurality of process integration servers.

19. The non-transitory computer readable storage medium of claim 13, wherein the central monitoring framework includes one or more integrated monitoring tools for monitoring the plurality of process integration servers.

20. The non-transitory computer readable storage medium of claim 13, wherein plurality of process integration servers is configured to collate business data from a plurality of data stores located remotely.
